(19) United States
(12) Patent Application Publication
(10) Pub. No.: US 2014/0040157 A1
(43) Pub. Date: Feb. 6, 2014

(54) Offer Presentation for Crowdfunding

(71) Applicants: Jedidiah S. Cohen, New York, NY (US); Brian Meece, New York, NY (US); Vladimir Vukicevic, Roslyn Heights, NY (US); Alon Hillel-Tuch, Brooklyn, NY (US)

(72) Inventors: Jedidiah S. Cohen, New York, NY (US); Brian Meece, New York, NY (US); Vladimir Vukicevic, Roslyn Heights, NY (US); Alon Hillel-Tuch, Brooklyn, NY (US)

(73) Assignee: ROCKETHUB INC., New York, NY (US)

(21) Appl. No.: 13/563,813

(22) Filed: Aug. 1, 2012

(51) Int. Cl. G06Q 40/00

(52) U.S. Cl. 705/329

(57) ABSTRACT

Offers are presented to one or more users of a crowdfunding platform based upon information gathered from multiple users' activities across one or more campaigns. An offer may be provided to the fundraiser based on a campaign category, a campaign keyword, a campaign profile, offer profile or user activity history. A user profile may be used to determine an offer by comparing the profile to attributes of one or more offers. The selected offer can be presented to users such as funders, fundraisers and others.

### BACKGROUND

Individuals or companies often solicit other individuals to help fund projects. The Internet has allowed such campaigning to proceed on a global basis and engage far more individuals than ever before. In addition, the fundraisers and the campaigns have similarly expanded in variety. Crowdfunding may be used to describe the collective pooling of money or other resources to support a particular campaign. A campaign may be directed to a variety of subjects, causes, businesses, individuals, or entities. Crowdfunding websites typically involve monetary contributions to a campaign despite the variety of funders and campaigns (e.g., to fund an enterprise). Some crowdfunding websites provide funders the ability to, for example, search for a campaign, information about an enterprise, or subject matter or filter campaigns based on popularity or subject matter. Information about an enterprise may include, for example, background information about the fundraisers, the objectives of the enterprise, funding goals, or consideration by the enterprise for funders. As an example, a fundraiser may be a musical group seeking to fund the enterprise of mounting a tour. The information about such an enterprise may include information about members of the band, the prospective tour schedule, samples of music by the band, or a video pitch for funding by members of the band. The band may offer a discount on concert tickets to funders as consideration for funding its campaign to mount a tour. Funders and fundraisers alike, however, may have difficulty determining in what campaigns to participate or what offers are available.

### BRIEF SUMMARY

According to an implementation of the disclosed subject matter, funding to a campaign account may be received from at least one funder, the campaign account associated with a campaign and at least one fundraiser. An offer may be determined based on, for example, a campaign category, a campaign keyword, and a fundraiser profile. The offer may be presented to the fundraiser.

A campaign profile may include, for example, an industry name, a campaign type, a campaign objective, a campaign category, a campaign keyword, a campaign purpose, a campaign geographic location, a campaign fundraising goal, a campaign total funds raised, and a campaign time limit. A campaign keyword may include at least one word in a description of a Standard Industrial Classification system, at least one word in a description of a North American Industry Classification System code, at least one word included in a campaign profile, and at least one word included in a fundraiser profile. A fundraiser profile may include a record of a click-through of a previous offer. An offer may be presented based on the attainment of a campaign fundraising goal, the expiration of a campaign deadline. An offer may be determined based on a geographic location.

In an embodiment, a campaign account may be funded based on contributions from a plurality of funders. The campaign account may correspond to a campaign having a campaign profile. Offers may be stored, for example, in a database. At least one of the offers may have an offer profile. At least one of the offers may be selected based on the campaign profile and the offer profile. In addition, the offer may be transferred to another campaign in exchange for virtual currency. The offer may be presented to the fundraiser.

An offer profile may include an offer category, an offer geographic location, and at least one keyword. Selection of one the offers may be based on matching a keyword stored in the offer profile with a keyword stored in the campaign profile or fundraiser profile. Selection of an offer may also be based on matching a campaign category stored in the campaign profile with an offer category stored in the offer profile. An offer may include a discount, have an expiration date, and be priced in a virtual currency.

In an embodiment a database may store a campaign account. A processor may be connected to the database and configured to receive funding to the campaign account from at least one funder. The campaign account may be associated with a campaign and at least one fundraiser. An offer may be determined based on, for example, a campaign category, a campaign keyword, and a fundraiser profile. The processor may be configured to present the offer to the fundraiser. In addition, the processor may be configured to present an offer based on the attainment of a campaign fundraising goal or the expiration of a campaign deadline. It may determine an offer based on a geographic location.

According to an embodiment, a database may store a campaign account. A processor may be connected to the database. The processor may be configured to receive funding to a campaign account based on contributions made by funders. The campaign account corresponding to a campaign having a campaign profile. The processor may store a plurality of offers, for example, to the database. An offer may have an offer profile. The processor may be configured to select at least one of the offers based on the campaign profile and the offer profile. In addition, the processor may be configured to transfer the offer to another campaign in exchange for virtual currency or to provide the offer to the fundraiser.

As disclosed herein, in an implementation an activity history of campaigns of a fundraiser may be stored. Each campaign may have at least one funder. A fundraiser profile may be generated based on the activity history of the fundraiser. A customized recommendation of an offer based on the fundraiser profile and a crowdfunding profile. The offer may be provided to the fundraiser. A crowdfunding profile may include, for example, an offer profile, a campaign profile, a funder profile, and a fundraiser profile. An offer may include an offer for information about at least one prospective funder or an offer to subscribe to a service. A prospective fundraiser may be a person who has not made a contribution to one or more particular campaigns. An activity history may include a record of a click-through of a previous offer. In addition, an offer may be provided based on the attainment of a campaign fundraising goal or the expiration of a campaign deadline. An offer may also be determined based on a geographic location.

In an embodiment, funding of a campaign may be received based on a contribution of at least one funder. An activity history of the at least one funder may be stored. A funder profile may be generated based on the activity history of the at least one funder. A customized recommendation of an offer may be generated based on the funding profile and a crowdfunding profile. The offer may be provided to a funder. As before, a crowdfunding profile may include, for example, an offer profile, a campaign profile, a funder profile, or a fundraiser profile. In addition, an offer may be provided based on the attainment of a campaign fundraising goal or the expiration of a campaign deadline. An offer may be determined based on a geographic location.

A system is disclosed that may include a database that stores an activity history of campaigns of a fundraiser. Each of the campaigns may have one or more funders. A processor may be connected to the database. The processor may be configured to generate a fundraiser profile based on the activity history of the fundraiser and to generate a customized recommendation of an offer based on the fundraiser profile and a crowdfunding profile. The processor may be configured to provide the offer to the fundraiser.

In an embodiment, a database may store an activity history of one or more funders. A processor may be connected to the database. The processor may be configured to receive funding of a campaign based on a contribution of the one or more funders. An activity history of the one or more funders may be stored, for example, to the database. The processor may be configured to generate a funder profile based on the activity history of the one or more funders and it may generate a customized recommendation of an offer based on the funder profile and a crowdfunding profile. The processor may be configured to provide the offer to a funder.

Additional features, advantages, and implementations of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process flow in 3A and an example configuration in 3B for providing an offer according to embodiments disclosed herein.

FIG. 4 is an example configuration of databases and a server according to an embodiment of the disclosed subject matter.

FIG. 5 is an example process flow of a recommendation of an offer to a fundraiser according to an embodiment disclosed herein.

FIG. 6 is an example process flow of a recommendation of an offer to a funder according to an embodiment disclosed herein.

### DETAILED DESCRIPTION

The disclosed subject matter proposes techniques and arrangements to provide or recommend one or more offers to a funder, a fundraiser, or both a funder and a fundraiser. Some of the embodiments described herein may employ one or more databases to generate values that describe characteristics of a campaign, a campaign account, a fundraiser, a funder, or an offer. The data may be collected and referred to as a profile. One or more of the profiles may be stored in one or more databases that may be connected to a server. The server itself may have storage capacity for one or more of the profiles or it may be connected to databases that store values used to determine a profile. For example, a funder may make a contribution to a campaign account that is non-monetary, that is, it may be an offer. The offer may be an offer for discounted airline tickets. The funder may provide the offer either by directly soliciting the fundraiser of a campaign or by submitting the offer to the offer database. In an embodiment, the offer may be matched to one or more campaigns and be provided to one or more fundraisers.

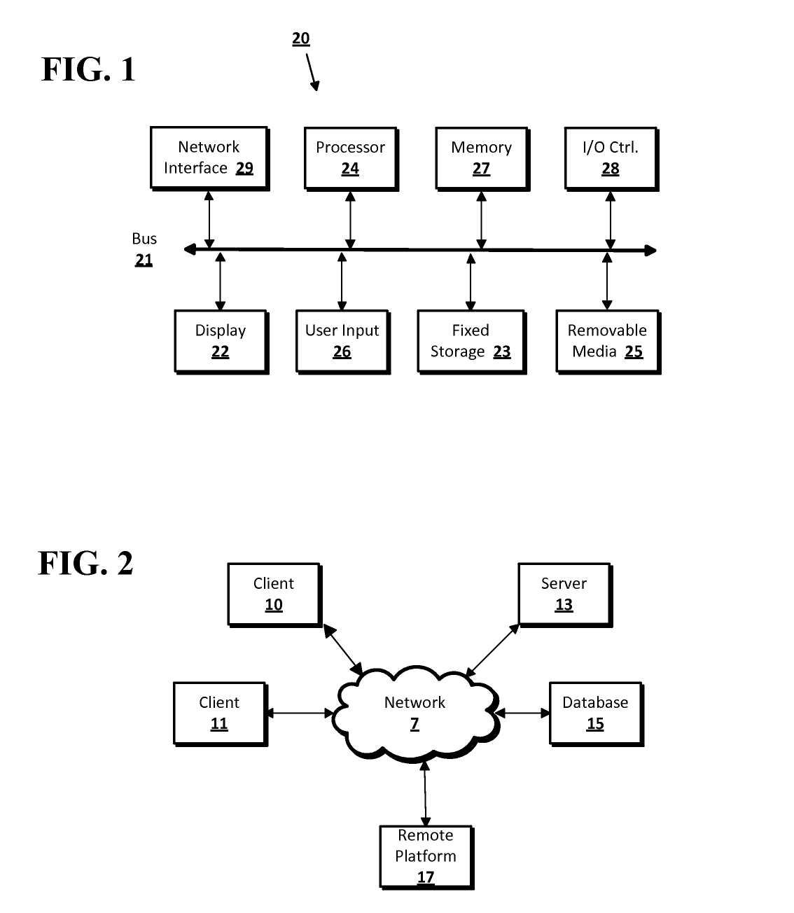

Implementations of the presently disclosed subject matter may be implemented in and used with a variety of component and network architectures. FIG. 1 is an example computer 20 suitable for implementing implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

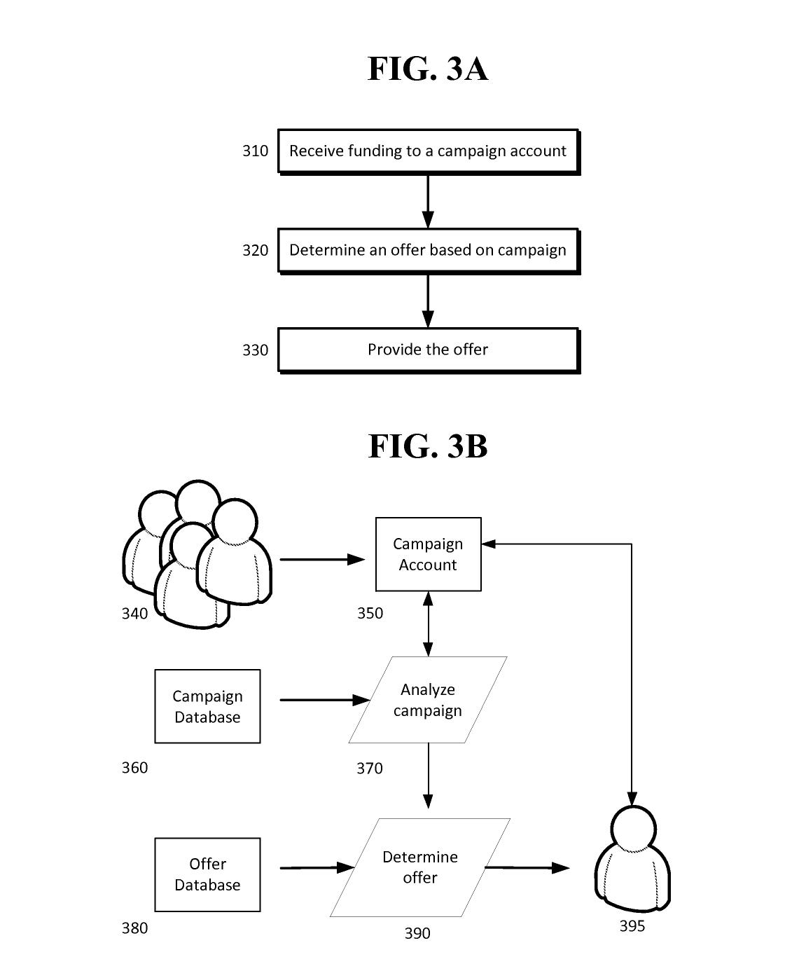

As shown in FIG. 3A, funding to a campaign account may be received from at least one funder at 310. The campaign account may be associated with a campaign and at least one fundraiser. As stated earlier, a funder may be an individual who desires to fund (e.g., contribute to) a campaign. A funder may do so by providing a monetary contribution to a campaign or a non-monetary contribution (e.g., an offer or referral).

A campaign may be a request for support from a community of funders. A campaign may be an organized effort to collect crowdsourced funding (i.e., crowdfunding) for a new or ongoing enterprise (e.g., a start-up business, an equipment purchase, an individual request, a charity, or a request for a contribution on behalf of another). A funder may be an individual, group of individuals, an enterprise or business, or other entities (e.g., a funder, a fundraiser, or a third party). A funder may have a funder account that is maintained by the server 13 operating a crowdfunding website (or platform) or utilize resources external to the website (e.g., a bank account, a credit card, or an electronic payment account). All or part of an amount credited to a funder's account may be utilized to fund a campaign at the discretion of the funder. A funder may fund a campaign in ways other than transferring currency to a campaign account.

A fundraiser may be a person, company, or other entity associated with a campaign, such as a campaign fundraiser, an affiliate of a campaign fundraiser, an employee or agent of a company or other entity that has control or influence over the disposition of funds in a campaign account, or an administrator of a campaign account. For example, a fundraiser may be a musical artist seeking funding for a tour, a school teacher seeking equipment for a science course, or a software developer seeking funding to develop software for a video game.

A campaign may have information associated with it such as background information about the fundraisers, the objectives of the enterprise, funding goals, or consideration by the enterprise for funders. The information may be collected, analyzed, or organized as a campaign profile that may be queried and stored in a database. For example, a campaign profile may include a campaign category, that is, a campaign may belong to a particular campaign category (e.g., musician, start-up business, school project, science fund, or individual compensation). A campaign profile may include, for example, an industry name (e.g., trademarked name or generic field of industry such as mobile devices), a campaign type (e.g., a start-up business, equipment purchase, or non-profit organization funding), a campaign objective or purpose (e.g., raise a specified amount of money, or obtain equipment), and a campaign keyword. A campaign profile may include a campaign geographic location, a campaign fundraising goal, a campaign total funds raised, and a campaign time limit. Campaign profiles may be themselves analyzed for commonalities (i.e., characteristics shared among two or more campaign profiles) and grouped accordingly. For example, a commonality among several campaign profiles may be music artists seeking money for an equipment purchase for a concert tour. Campaign profiles with such features in common may be targeted with a specific offer or be used to target specific funders or prospective funders with an offer. A funder may wish to fund a campaign in ways other than transferring currency to the campaign account (e.g., provide an offer).

A campaign may have one or more keywords associated with it and the one or more keywords may be associated with a campaign profile (or multiple profiles). For example, a fundraiser (e.g., the administrator of a campaign or person/entity that initiates/oversees a campaign) may enter a description of a campaign and background information about the benefactor of a campaign to improve the chances of the campaign being perceived as legitimate A campaign keyword may include at least one word in a description of a Standard Industrial Classification system, at least one word in a description of a North American Industry Classification System code, at least one word included in a campaign profile, and at least one word included in a fundraiser profile (described below).

Returning to FIG. 3A, an offer may be determined based on, for example, a campaign category, a campaign keyword, a fundraiser profile, or any combination thereof at 320. It may also be determined based on an offer having an offer profile (described below). A fundraiser may establish a campaign account into which funds may be received or to which offers to make contributions of physical items may be received (e.g., a funder may provide an item for which a campaign is seeking funding in lieu of funds). A campaign account may receive funds, that is, actual or virtual currency. An actual currency may be a medium of exchange issued by or on behalf of a sovereign government. Examples of actual currency include dollars, euros, Swiss francs, or kroner. Virtual currency may be a medium of exchange issued by or on behalf of an entity other than a sovereign government. Examples of virtual currency may include in-game currency such as Station Cash in Everquest II published by Sony Online Entertainment, virtual world currency such as Linden Dollars used in Second Life by Linden Lab, Facebook Credits, or electronic cash such as Bitcoin. A fundraiser may have more than one campaign account (e.g., a fundraiser may operate multiple campaigns, each having a separate campaign account into which funds are received).

Information in a fundraiser profile may include, without limitation, username, a birthdate, an image such as a profile image, a mobile phone number, an email address, a social network user identifier, a gender, a video content, an audio content, a location, and a country. In addition, the fundraiser may include background description. For example, a fundraiser may represent a biotechnology start-up business and operate multiple campaigns directed to obtaining funds to obtain equipment needed to perform experiments. The background information may indicate a history of past campaigns, successes of the company, the purpose of the company, or information on other campaigns concurrently operated by the fundraisers. The fundraiser profile may also indicate whether or not a fundraiser is interested in receiving offers. The fundraiser profile may also include information about a fundraiser's activities. For example, it may include information that is aggregated based upon the fundraiser's activity on the crowdfunding website or platform (i.e., including the parent site and any related pages or sites). Examples of such activity may include a search executed by the fundraiser, a funder profile viewed by the fundraiser, an offer viewed by the fundraiser, an offer accepted by the fundraiser, or analytics of the fundraiser's campaigns (e.g., performance of past and present campaigns administrated by the fundraiser). The fundraiser profile information may be maintained, for example, in a database 15 that is connected to a server 13 via a network 7 as shown in FIG. 2.

A fundraiser profile may also refer to a profile that is generated based on an analysis of two or more individual fundraiser profiles. For example, fundraisers who identify themselves as a biotechnology company may be grouped together in a database based on the shared characteristic (e.g., a biotechnology fundraiser profile). An offer may be filtered to be provided only to those fundraiser profiles that match a biotechnology fundraiser profile. An individual fundraiser profile may be compared to the generated biotechnology profile in some configurations. In another configuration, an individual fundraiser profile may be analyzed and grouped into a particular category upon creation of the fundraiser account. A generated fundraiser profile may be used to target individual fundraisers with offers by matching an offer profile to a specific generated fundraiser profile such that individual fundraiser profiles matching the specific generated fundraiser profile may receive the offer. Offers may be targeted based on less than all aspects of a fundraiser profile. That is, if a profile is for women, aged 30-45, who work on Alzheimer's disease, an offer may only target fundraisers whose profiles have been associated with Alzheimer's disease (i.e., irrespective of age or gender).

Similar to the fundraiser profile, a funder profile may also be developed or created and stored. A funder profile may include the same information as a fundraiser profile. It may, for example, contain information about the funder submitted by the funder (e.g., birthdate, social network information, email address, phone number, etc.) or that is determined based on the activity of the funder. For example, the funder may have a history of contributing to campaigns that belong to a particular profile group (e.g., school projects, music artists, or biotechnology start-up companies). A database 15 may maintain, for example, a history of searches performed on a crowdfunding website or platform an offer viewed by the funder, an offer accepted by the funder, a history of contributions made by the funder. A fundraiser or funder profile may also include a record of a click-through of a previous history. A funder or fundraiser profile may be based on the activity of a funder or fundraiser on a crowfunding website or platform and used as part of an offer recommendation system (described in more detail below).

A funder profile may also refer to a profile that is generated based on an analysis of two or more individual funder profiles, similar to a fundraiser profile as described above. A generated funder profile may be used to target individual funders with offers by matching an offer profile to a specific generated funder profile such that individual funder profiles belonging matching the specific generated funder profile may receive the offer. Offers may be targeted based on less than all aspects of a funder profile.

A funder and fundraiser are not mutually exclusive, that is, a funder may also act as a fundraiser for a campaign. A person may initiate a campaign to fund a music tour for a band and be a funder for a campaign to fund an animal shelter. Thus, profile information for a funder and a fundraiser may be stored in the same database or maintained as a single record for an individual account (i.e., registered user of a crowdfunding website or platform). Similarly, although a single record may be maintained for an individual account, the activity of the account may be separated into activity associated with fundraising and activity associated with funding and used to generate a profile.

FIG. 3B is an example configuration of various databases that may be connected over a network by a crowdfunding server 13. Funders 340 provide funding (monetary or non-monetary) that is deposited or credited to a campaign account 350. The campaign account is controlled by the fundraiser 395. The campaign may be analyzed based on information contained in a campaign database 360 (e.g., campaign profile information, a keyword, background, or campaign purpose). The status of the campaign account may also be factored into a campaign analysis at 370. For example, the progress of a campaign may be determined, the profile of funders who have contributed may be examined, or the extent of non-monetary contributions may be determined (e.g., has a funder offered to provide equipment requested instead of funds or currency to purchase the equipment). An offer database may contain information related to an assortment of offers and store offer profiles. An offer may be determined at 390 by comparing the information contained in the offer database 380 with the campaign analysis 370 information. The offer may be provided to the fundraiser 395.

An offer profile may include a geographic location, an offer category, and a keyword. As with the other profiles described elsewhere, information contained in the offer profile may overlap with information contained in other profiles. An offer profile database may be utilized to maintain the information or it may be maintained as a separate database. The offer profile may be used to determine relationships between offers contained in an offer database and for recommending offers to funders or fundraisers.

The system configuration shown in FIG. 3B may operate on, for example, a campaign for a music artist to mount a tour that may be partially funded. The offer database 380 may contain offers for discounted airline tickets to locations the artist has indicated in the background information of the campaign profile that is stored in the campaign database 360. The campaign analysis 370 may determine, for example, that the campaign is approximately 80% funded (or that the campaign goal is 80% fulfilled) and that the campaign expires shortly. This information may be used to filter or screen the offer database for offers that are immediately available. As another example, the campaign may not be set to expire for several months and offers may need to be filtered to determine those offers that do not expire shortly or before the expiration of the campaign. In still another example, the campaign may be a request for equipment for the tour and the 80% complete figure may reflect that 80% of the items requested for the tour have been provided (e.g., the fundraiser may check-off equipment that has been purchased with funds already provided). An inventory of the items provided and not-yet provided for may be used to filter the offer database for offers that may assist the fundraiser obtain items not yet provided. For example, if the fundraiser is still seeking funds to purchase an amplifier, the offer database may be screened for offers from funders who may assist with such an item.

Returning to FIG. 3A, the offer may be presented to the fundraiser at 330. The offer may be selected based on a campaign profile and an offer profile. An offer may be an offer for a discount on a particular item or service. For example, selection of one or more offers to present to a fundraiser (or funder) may be based on matching at least one keyword stored in the offer profile with at least one keyword stored in the campaign profile or the fundraiser profile. It may be based on matching a campaign category stored in the campaign profile with an offer category stored in the offer profile.

An offer may provide information to a fundraiser such as potential funders who might be interested in contributing to the campaign or an invitation to join a social network or suggestion/recommendation of a social network connection (described below). An offer may also be an offer to perform a service. For example, an animal shelter may be seeking funding for a new facility and a construction company may offer to provide its services for free or at a discounted rate. An offer may also be an advertisement. An offer may be provided based on the attainment of a campaign financing goal. For example, a funder may offer to match the funds raised by a campaign if it reaches a $10,000 milestone. An offer may be presented based on the expiration of a campaign deadline. For example, if a campaign fails to reach a certain goal within a specified time, a funder may make a contribution to the campaign or provide a non-monetary offer. An offer may be determined based on a geographic location. For example, if a contractor operates in a particular state, the contractor may limit an offer for services to that state. An offer may constitute a referral for a service or item.

An offer may also describe when a campaign account (or funder account) is credited in exchange for an action completed by an entity. The entity can be a funder, a fundraiser or a third party. All or part of an amount credited to a funder or fundraiser account may be utilized to fund a campaign. An action may include, for example, a purchase of a product by the funder, by the fundraiser or by another. For example, a manufacturer or a retailer can issue a promotion that causes the user account (a funder account, a fundraiser account to be credited a certain amount when the user (a funder, a fundraiser, a third party, etc.) purchases an item or combination of different items, a minimum number of items, a minimum value of items, makes the purchase within a given time window and/or from a particular source. For example, a user may receive five credits when the user purchases an airline class upgrade, completes a stay at a hotel, purchases an automobile, etc. Likewise, the account may be credited two dollars when the user buys at least three boxes of tissue or when the user spends at least fifty dollars at a restaurant. Likewise, the account may be credited five percent of the purchase value of a particular type of perfume, up to a maximum of twenty five dollars. The action may have a time-based component. For example, an account may be credited when a user makes any purchase at a store on a Tuesday or Wednesday, subscribes to a service before a given date and/or time. An action may include completing a survey. The amount credited may depend on the answers given by the user to the survey. For example, completing all of the questions in the survey may result in a greater amount being deposited in the account than partially completing the survey. An action may include subscribing to a service such as an Internet Service Provider (ISP) service or obtaining a membership to a fitness club. An action may include accepting an offer, such as an offer to apply for a credit card or to purchase a given product.

A social network may include a social networking site and its associated content (including the network of users or an internet forum). A social networking site may permit users (e.g., funders and fundraisers), once registered, to connect with other acquaintances or friends. Typically, a user is provided recommendations of individuals and/or other entities with whom the user may like to associate (or know) based on a profile (e.g., similar to a funder/fundraiser profile) or people with whom the user has already associated with on the website. A user may request, reject, accept, or ignore a friend invitation with other users of the social networking site. In some social networking systems, a user may simply follow the web postings of another user (e.g., text-based messages posted by the other user). Social networking sites typically use terms such as “friend,” “like,” or “follow” to describe a user's association with another user, content, or entity. For example, a user may elect to follow a particular celebrity or a restaurant. In doing so, the user may, for example, receive offers (e.g., discounts, advertisements, or promotions), images or other like content, or be able to view or receive the postings from the celebrity or restaurant.

As used herein, an offer may be presented to a fundraiser to join the social network of funders who have been determined to have profiles that are matched with the fundraiser's campaign. As another example, a fundraiser may receive contributions on multiple campaigns from a particular funder and may be offered to connect to the funder's social network. An action can include changing a membership in a social network. For example, an account can be credited when a user “likes” or “follows” a given entity on a social network or joins a social network of an entity (a person, a company, a product, etc.). Likewise, an action can include mentioning an entity in a blog or on a social network. Changing a membership in a social network can include changing the state of a social network in any way.

In accordance with various implementations of the presently disclosed subject matter, rewards programs may be a source of funding for a user account. For example, airline frequent flyer points, hotel points, or rental car points may be converted into funding for a funder account or campaign account. A request may be received from the a crowdfunding website user to convert a given amount of points in a rewards program account into an actual or virtual currency deposit into a crowdfunding account (e.g., funder account or campaign account). The given amount of reward points may be deducted from the rewards program account. An exchange rate may be determined between rewards points and a denomination of the crowdfunding account (e.g., funder account or campaign account), either in a virtual currency or an actual currency. For example, each frequent flyer point may be worth 3 virtual currency units, $0.01, etc., in the crowdfunding account. The amount to be credited to the funder or campaign account may be calculated based on the amount of rewards points being redeemed and the exchange rate. For example, if a crowdfunding website user wishes to convert 1200 rewards points into crowdfunding virtual currency, 1200 rewards points may be deducted from his rewards account and, assuming an exchange rate of 3 crowdfunding virtual currency units per reward point, 3600 virtual currency units may be deposited in the funder or campaign account. A denomination may be the units in which value stored in an account is expressed. For example, an account may store value denominated in dollars, pounds, points, virtual currency units, etc.

In another implementation, the amount to deposit into the funder or campaign account may be established, an exchange rate may be determined, and the correct number of rewards points to deduct from the rewards account may be calculated. The calculated number of rewards points may be deducted from the rewards account and the correct amount may be deposited into the funder or campaign account. For example, a funder or fundraiser may specify that $300 be deposited in a funder or campaign account based on points in a rewards account. The exchange rate between rewards points and dollars may be determined to be $0.03 per reward point. In that case, it may be determined that 10,000 rewards points should be deducted from the rewards account for $300 to be deposited in the funder or campaign account.

Likewise, in various implementations, funder or campaign account credit (e.g., actual currency, virtual currency, or other carriers of value) may be converted back into rewards account or other account credits.

The amounts deducted from one account and/or credited to another account may be subject to fees that may be charged by the crowdfunding platform and/or other service providers. For example, a percentage of funds transferred or a fixed fee may be charged when funds are credited to and/or debited from a funder or campaign account. The fee may be imposed in transferring value from an external account (such as a rewards account) into a funder or campaign account and/or vice versa. A fee may be imposed in transferring value from one funder or campaign account to another (e.g., from a funder account to a campaign account or vice versa). The fee may be charged to the transferor, the transferee or both.

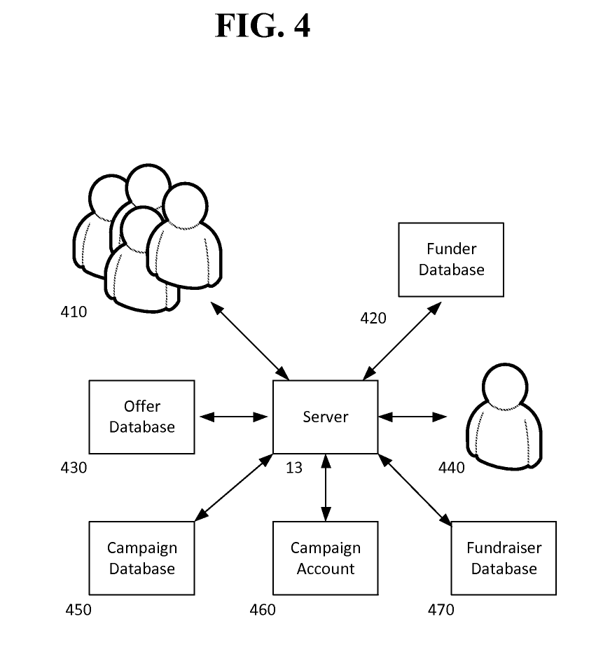

FIG. 4 is an example configuration of databases for a crowdfunding platform. Funders 410 may subscribe to a crowdfunding platform or website that is hosted on a server 13. The server may, for example, negotiate the exchange of information between a funder database 420, an offer database 430, a campaign database 450, a campaign account 460, a fundraiser database 470, and a fundraiser 440. An offer database 450 may store information about offers in that may be provided to a funder, funders having a certain funder profile, a fundraiser, or fundraisers having a certain profile. The information about offers may be maintained in the form of an offer profile as described earlier. A campaign database 450 may include campaigns that have expired and on-going campaigns. It may maintain a campaign profile that may include, for example, background information, keywords, a campaign goal as described above. A funder database 420 may include profile information and also may maintain account information. For example, a funder may link electronic accounts such as a bank or other virtual currency accounts to the funder. A fundraiser database 470 may also maintain profile information as stated above. The campaign account 460 may maintain information about the progress of the campaign, time information about the campaign (e.g., when a campaign expires), information to contact a fundraiser (e.g., to send physical items), or funds.

The databases shown in FIG. 4 are displayed as separate from the server 13, however, one or more of the databases may be combined in some configurations. The information contained in the databases shown in FIG. 4 may, in some configurations, be maintained as a single database that, for example, is connected to (physically or by a network 7) or accessible by the server 13. The server 13 may perform calculations or analytics regarding amounts to deposit into funder or campaign account, categorizing or grouping profiles based on shared traits, or presenting offers based on matching a profile to an offer profile. Similarly, the server 13 may provide connections to outside networks such as banks, social networks, or other forums.

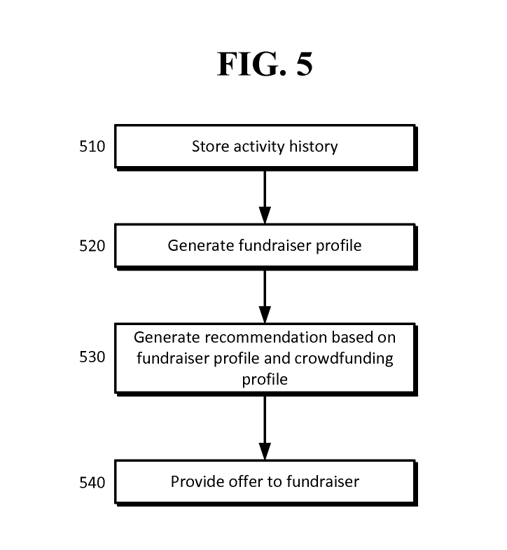

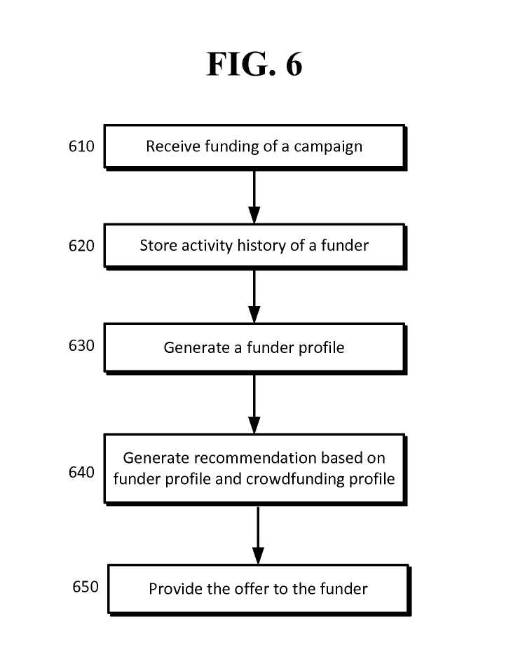

FIGS. 5 and 6 show exemplary process flows of offer recommendation mechanisms for a fundraiser or a funder respectively. In an embodiment, shown at 510, an activity history of a plurality of campaigns of a fundraiser may be stored to, for example, a database 15 that is connected to a server 13. A fundraiser or funder profile based on the activity history of the fundraiser may be generated at 520. Each of the campaigns may have one or more funders. For example, a fundraiser may be a school that has multiple campaigns directed toward various projects. The campaigns may be run concurrently and kept separate in some configurations. For example, the school may establish a single campaign account into which funds are received or it may have a separate campaign account for each campaign.

An activity history may be based on any of the profiles described earlier (i.e., a crowdfunding profile). It may be a funder or fundraiser's activity on a crowdfunding website or platform. An activity history may be a record of a previous click-through of an offer. A click-through, for example, may be selection of an offer using a computing device (e.g., a mouse click). An activity history may be associated with an account of a fundraiser or funder. For example, a funder or fundraiser may subscribe to a website by creating a username and password as part of their profile (e.g., account). The generated funder or fundraiser profile may be updated over time based on actions or activities of a funder or fundraiser.

A customized recommendation of at least one offer may be generated based on the fundraiser profile and a crowdfunding profile at 540 and provided to a fundraiser at 550. For example, a biotechnology start-up company may initiate a campaign for funds to conduct experiments directed to a novel Alzheimer's disease treatment based on promising preliminary experiments performed by the company. The company may have initiated other similar campaigns for other areas of research (e.g., drug screenings, funding for scientific equipment, animal model creation). The customized recommendation may analyze offers for which the fundraiser has previously indicated an interest either explicitly or implicitly. For example, in a campaign for funds for a drug screening, the fundraiser may have accepted an offer for a discount on reagents. The offer may be for information relating to a funder or an offer to subscribe to a service. For example, the biotechnology company may receive information on prospective funders (e.g., funders who have not yet contributed to the company's campaign) who have been identified by their contribution to one or more other biotechnology campaigns that have a profile similar to the present one.

The offer database, for example, may contain offer profiles and may analyze the offers to determine a relationship between offers. For example, offers may be deemed to have a relationship if they share keywords or a category. Mappings of relationships between offers may be performed periodically (e.g., hourly, weekly, monthly) by a server 13 or a processor connected to a database 15. An offer recommendation may also be influenced by offers viewed (or otherwise interacted with) by other fundraisers who had a similar profile to, for example, the biotechnology company. The analysis of the correlations or relationships between offers based on funders or fundraisers (or activities thereof), offer profiles, or campaign profiles may be performed in real-time or offline.

In an embodiment, funding of a campaign may be received based on a contribution of at least one funder at 610. An activity history of the at least one funder may be stored at 620. At 630, a funding profile based on the activity history of the at least one funder may be stored. A customized recommendation of an offer based on the funding profile and a crowdfunding profile may be generated at 640. The offer may be provided to a funder at 650. As described above, a recommendation may be based on relationships generated between offers, funders, fundraisers, or campaigns including the user of any of the profile databases described earlier. In FIG. 6, a funder may receive a recommendation for an offer. For example, a funder who has expressed, either explicitly or implicitly, an interest in an animal shelter may receive an offer to perform an action (as described above) such as filling out a survey regarding animal shelters in exchange for a virtual currency. In another example, a user who resides in Washington, D.C. but who makes contributions to software companies located in Silicon Valley may receive an offer for discounted plane tickets to San Francisco in exchange for making a contribution to a particular campaign. As with an offer recommendation to a fundraiser described above, a funder may receive an offer recommendation for a service where either funder performs a service or accepts a service in exchange for a currency that may be used to fund a campaign.

An opportunity to view or accept an offer or to contribute or accept contributions for a campaign may appear in various forms. For example, in a configuration the funder or fundraiser may be brought to an interface that permits the user to complete the action. For example, a user (e.g., funder or fundraiser) may be offered the opportunity to earn credits or convert non-cash points to a virtual currency for use on a crowdfunding platform or website. From a homepage a specific valuable-activity-offer may be featured. A user who clicks on that link may be brought to an interface allowing the user to complete the offer or select another offer of interest. Once an offer is completed and verified, the user's account may be credited with the non-cash points or credits and the user may contribute those credits to the campaign of their choice. An offer may be presented or accepted over conventional email.

In an embodiment, a configuration may feature a more conventional check-out process that may be analogous to a shopping cart found on many electronic commerce websites. For example, funders may be presented with the option to complete their contribution to a campaign in various ways. In some configurations, a funder may directly purchase contribution points or contribute funds to a campaign (i.e., the funder may enters credit card information to purchase virtual credits or contribute funds directly). In other configurations, a funder may complete one or more activities in exchange for virtual or actual currency (i.e., the funder earns credits by completing an offer). In still other configurations, a funder may convert non-cash points to credits (i.e., airline miles/credit card rewards points). One skilled in the art will recognize the advantages of a broader source of funding for crowdfunding projects, the ability to leverage latent activity value and non-cash value, and reduced credit card transaction fees.

In an embodiment, an offer is provided to a fundraiser or funder after the completion of a campaign. The presentation of the offer may be based on the success of the campaign. For example, a campaign that is 100% funded may be greater incentivized by an offer (e.g., a free airline ticket instead of a discounted ticket). Offers may be based on the ability of a fundraiser to spend the funds which the fundraiser has acquired. Offers may be customized based on a campaign category, keyword, offer profile, etc. A fundraiser may be presented with a series of referral offers. The referrals may be presented as web links, offer codes, or by any of the methods known in the art or described above. The offers may be broad and applicable to many fundraisers (e.g., a discount offer for legal vendor's services) or targeted to a specific niche (e.g., a discount on duplicating CDs for a musician). Targeted offers may be optimized based on industry, purpose, geography, or other filtering mechanisms as described above.

A system is disclosed that may include a database that stores an activity history of campaigns of a fundraiser. Each of the campaigns may have one or more funders. A processor may be connected to the database. The processor may be configured to generate a fundraiser profile based on the activity history of the fundraiser and to generate a customized recommendation of an offer based on the fundraiser profile and a crowdfunding profile. The processor may be configured to provide the offer to the fundraiser.

In an embodiment, a database may store an activity history of one or more funders. A processor may be connected to the database. The processor may be configured to receive funding of a campaign based on a contribution of the one or more funders. An activity history of the one or more funders may be stored, for example, to the database. The processor may be configured to generate a funder profile based on the activity history of the one or more funders and it may generate a customized recommendation of an offer based on the funder profile and a crowdfunding profile. The processor may be configured to provide the offer to a funder.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
storing, to a database, a campaign profile, the campaign profile comprising an indication of a fundraiser that receives funding from a plurality of funders of the campaign;
storing to the database an activity history of a plurality of campaigns of the fundraiser;
generating, by a processor, a fundraiser profile based on the activity history of the fundraiser;
generating, by the processor, a customized recommendation of at least one offer relevant to the campaign based on the fundraiser profile and a second profile selected from the group consisting of: an offer profile, a campaign profile, and a funder profile, wherein the at least one offer does not comprise actual currency; and
providing, by a processor, the customized recommendation of the at least one offer to the fundraiser.

2. (canceled)

3. The method of claim 1, wherein an offer is selected from the group consisting of: an offer of information about at least one prospective funder and an offer to subscribe to a service.

4. The method of claim 1, wherein the campaign is associated with a campaign category.

5. The method of claim 1, wherein the campaign is associated with a campaign keyword.

6. The method of claim 1, wherein the activity history comprises a record of a click-through of a previous offer.

7. The method of claim 1, further comprising determining an offer based on a geographic location.

8. The method of claim 1, wherein the campaign profile includes at least one selected from the group of: a campaign purpose, a campaign geographic location, a campaign keyword; a campaign category; a campaign fundraising goal, a campaign total funds raised, and a campaign time limit.

9. The method of claim 1, wherein the offer profile includes at least one selected from the group of: an offer category, an offer geographic location and at least one offer keyword.

10. A method comprising:
storing, to a database, a campaign profile, the campaign profile comprising an indication of a fundraiser that receives funding from a plurality of funders of the campaign;
receiving funding of a campaign based on a contribution of at least one funder;
storing to a database an activity history of the at least one funder;
generating, by a processor, a funder profile based on the activity history of the at least one funder;
generating, by a processor, a customized recommendation of at least one offer based on the funder profile and a second profile selected from the group consisting of: an offer profile, a campaign profile, and a fundraiser profile, wherein the at least one offer indicates a reward for a funder performing an action, and the at least one offer does not comprise actual currency; and
providing, by a processor, the customized recommendation of the at least one offer to a funder.

11. (canceled)

12. The method of claim 10, wherein the campaign is associated with a campaign category.

13. The method of claim 10, wherein the campaign is associated with a campaign keyword.

14. The method of claim 10, wherein the activity history comprises a record of a click-through of a previous offer.

15. The method of claim 10, further comprising determining an offer based on a geographic location.

16. The method of claim 10, wherein the campaign profile includes at least one selected from the group of: a campaign purpose, a campaign geographic location, a campaign keyword; a campaign category; a campaign fundraising goal, a campaign total funds raised, and a campaign time limit.

17. The method of claim 10, wherein the offer profile includes at least one selected from the group of an offer category, an offer geographic location and at least one offer keyword.

18. The method of claim 10, wherein the offer includes at least one selected from the group consisting of: a discount and an expiration date.

19. A system comprising:
a database to store a campaign profile and an activity history of a plurality of campaigns of a fundraiser, the campaign profile comprising an indication of the fundraiser that receives funding from a plurality of funders of the campaign;
a processor connected to the database, the processor configured to:
generate a fundraiser profile based on the activity history of the fundraiser;
generate a customized recommendation of at least one offer relevant to the campaign based on the fundraiser profile and a second profile selected from the group consisting of: an offer profile, a campaign profile, and a funder profile, wherein the at least one offer does not comprise actual currency; and
provide the customized recommendation of the at least one offer to the fundraiser.

20. (canceled)

21. The system of claim 19, wherein an offer is selected from the group consisting of: an offer of information about at least one prospective funder and an offer to subscribe to a service.

22. The system of claim 19, wherein the campaign is associated with a campaign category.

23. The system of claim 19, wherein the campaign is associated with a campaign keyword.

24. The system of claim 19, wherein the activity history comprises a record of a click-through of a previous offer.

25. The system of claim 19, the processor further configured to determine an offer based on a geographic location.

26. The system of claim 19, wherein the campaign profile includes at least one selected from the group of: a campaign purpose, a campaign geographic location, a campaign keyword; a campaign category; a campaign fundraising goal, a campaign total funds raised, and a campaign time limit.

27. The system of claim 19, wherein the offer profile includes at least one selected from the group of an offer category, an offer geographic location and at least one offer keyword.

28. A system comprising:
a database to store a campaign profile and an activity history of at least one funder, the campaign profile comprising an indication of the fundraiser that receives funding from a plurality of funders of the campaign;
a processor connected to the database, the processor configured to:
receive funding of a campaign based on a contribution of the at least one funder;
store an activity history of the at least one funder;
generate a funder profile based on the activity history of the at least one funder;
generate a customized recommendation of at least one offer based on the funder profile and a second profile selected from the group consisting of: an offer profile, a campaign profile, and a fundraiser profile, wherein the at least one offer indicates a reward for a funder performing an action, and the at least one offer does not comprise actual currency; and
provide the customized recommendation of the at least one the offer to a funder.

29. (canceled)

30. The system of claim 28, wherein the campaign is associated with a campaign category.

31. The system of claim 28, wherein the campaign is associated with a campaign keyword.

32. The system of claim 28, wherein the activity history comprises a record of a click-through of a previous offer.

33. The system of claim 28, the processor further configured to determine an offer based on a geographic location.

34. The system of claim 28, wherein the campaign profile includes at least one selected from the group of: a campaign purpose, a campaign geographic location, a campaign keyword; a campaign category; a campaign fundraising goal, a campaign total funds raised, and a campaign time limit.

35. The system of claim 28, wherein the offer profile includes at least one selected from the group of an offer category, an offer geographic location and at least one offer keyword.

36. The system of claim 28, wherein the offer includes at least one selected from the group consisting of: a discount and an expiration date.
